(19) United States
(12) Patent Application Publication
(10) Pub. No.: US 2002/0186816 A1
(43) Pub. Date: Dec. 12, 2002

(54) X-ray tube, particularly rotating bulb x-ray tube

(76) Inventors: Joerg Freudenberger, Baiersdorf (DE); Erich Hell, Erlangen (DE); Detlef Mattern, Erlangen (DE); Peter Schardt, Hoechstadt (DE)

Correspondence Address: SCHIFF HARDIN & WAITE, 6600 SEARS TOWER, 233 S WACKER DR, CHICAGO, IL, 60606-6473, US

(21) Appl. No.: 10/134,130

(22) Filed: Apr. 29, 2002

(30) Foreign Application Priority Data
Apr. 27, 2001 (DE) 10120808.1

(51) Int. Cl. H01J 35/10

(52) U.S. Cl. 378/144; 378/143

(57) ABSTRACT

An x-ray tube has a vacuum housing containing an electron-emitting cathode and an anode on which the electron beam, accelerated with an electrical field, is incident. The x-ray tube contains a magnet system which generates a main magnetic field with spring focus for deflecting and focusing the electron beam such that the focal spot on the incident surface of the anode can be azimuthally varied. A coil is located spatially separate from the main magnetic field and the alignment of the focal spot relative to the incident surface can be influenced therewith. The coil is fashioned and arranged such that a non-uniform magnetic field that effects a parallel alignment of the focal spot in the spring function is generated therewith.

### BACKGROUND OF THE INVENTION

1. Field of the Invention

The present invention is directed to an X-ray tube, particularly a rotating bulb X-ray tube.

2. Description of the Prior Art

Given utilization of, in particular, rotating bulb x-ray tubes as employed in computed tomography, the so-called spring focus effect is used for improving the resolution. The electron beam is deflected in the φ direction, i.e. in the circumferential direction of the dish edge of the anode, using a suitable magnetic field. As a result, different focal spot positions are obtained. As a result of the offset of the focal spot, the projection image is also offset by half a sampling period of the detector. The detector resolution can be doubled by means of such a spring focus in the x-ray tube.

So that a higher resolution also can be utilized as a result of the higher scan rate, it is important that no secondary effects in turn degrade the resolution given an azimuthal displacement of the focal spot in the tube. Such a disadvantageous effect can, for example, be a distortion (slanting position) of the line-shaped focal spot that is desired in and of itself given an offset of the focal spot (“windshield wiper effect”).

German PS 198 10 346, corresponding to U.S. Pat. No. 6,339,635, discloses an x-ray tube wherein the spring focus is achieved by a quadruple magnet system. In this known x-ray tube, a solenoid is arranged immediately adjacent to the quadruple magnet system, i.e. practically at the neck of a comically expanding vacuum housing. The iron core and the coil of the solenoid surround the vacuum housing. An additional magnetic field that influences the electron beam is generated by the solenoid, this opposing spreading of the electron beam, and thus preventing an unwanted deformation of the focal spot given an azimuthal displacement of the focal spot. The magnetic field generated with the solenoid is largely uniform and cannot contribute to eliminating or preventing a distortion (slanting position) of the focal spot.

### SUMMARY OF THE INVENTION

An object of the present invention is to provide an x-ray tube of the type described above wherein the aforementioned distortions of the focal spot given the use of a spring focus arrangement are avoided.

This object is achieved in accordance with the invention in an x-ray tube with a spring focus arrangement wherein a non-uniform magnetic field is generated with a coil arrangement that can align the focal spot such that it lies practically parallel to the initial focal spot in the azimuthal deflection. Focal spot rotation can be practically completely compensated with such a coil arrangement.

The x-ray tube with the inventive coil arrangement has at least one air coil, i.e. a coil without an iron core, that is arranged in that region wherein the electron deflection occurs. Given an x-ray tube with conically fashioned vacuum housing, thus, this coil is disposed in the conical part of the tube.

So that an adequately good, parallel deflection can be achieved, an optimally long path is advantageous along which the non-uniform magnetic field acts. The air coil is therefore fashioned as a narrow, elongated flat coil that is disposed at one side at a suitable place in the x-ray housing. The coil proceeds practically parallel to the electron path in the tube.

Preferably, the coil is secured directly to a guide body that conforms to the exterior shape of the vacuum housing and is disposed with a gap between the guide body and the exterior of the housing that allows a coolant to flow through. Such an arrangement has the advantage that the guide body is divisible in the longitudinal direction, so that ease of assembly is considerably improved. With other coils, for example, a solenoid coil, neither the desired effects nor this advantages can be achieved.

### DESCRIPTION OF THE DRAWINGS

FIG. 1 is a schematic illustration of a rotating bulb x-ray tube constructed and operating in accordance with the invention.

FIG. 2 shows the position of two focal spots that can be generated according to prior art tubes.

FIG. 3 shows the position of the two focal spots in the inventive tube.

### DESCRIPTION OF THE PREFERRED EMBODIMENTS

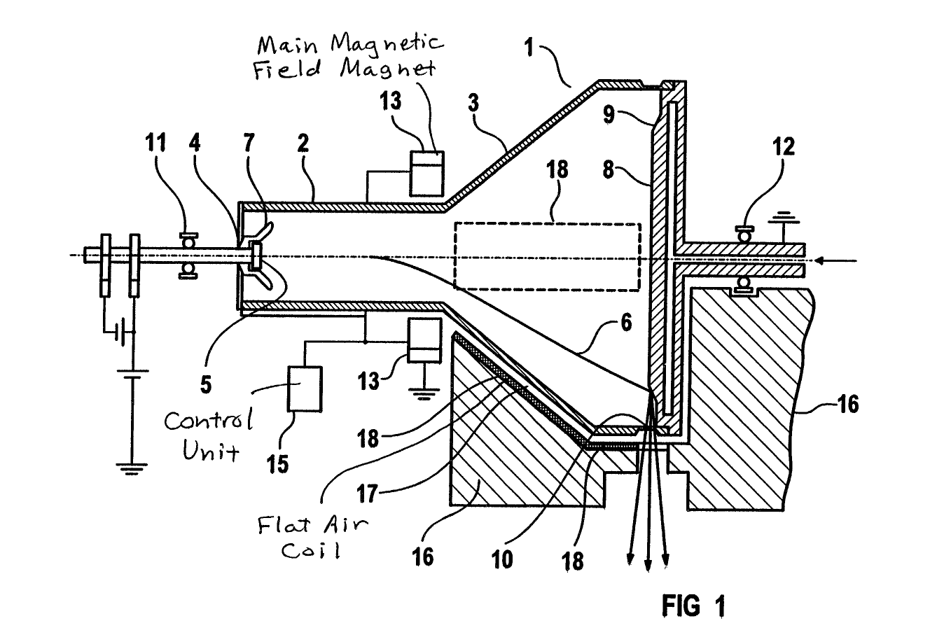

FIG. 1 is a schematic illustration of a rotating bulb x-ray tube having a vacuum housing 1 with an essentially cylindrical region 2 and a region 3 adjoining thereto that expands in the shape of a conical frustum.

A cathode arrangement 4 with an emitter 5 is situated at the end of the vacuum housing 1, an electron beam 6 having an essentially circular cross-section being generated therewith during operation of the tube. A focusing electrode 7 sets the size of the electron beam. The anode 8 arranged at the other end of the vacuum housing contains an anode dish 9 coated with tungsten on which the electron beam 6 strikes. The x-rays thereby generated emerge from the vacuum housing 1 through an annular beam exit window 10.

Appropriate bearings 11, 12 are provided in order to enable rotation of the vacuum housing 1. The rotation of the vacuum housing 1 is accomplished by drive means that are not shown.

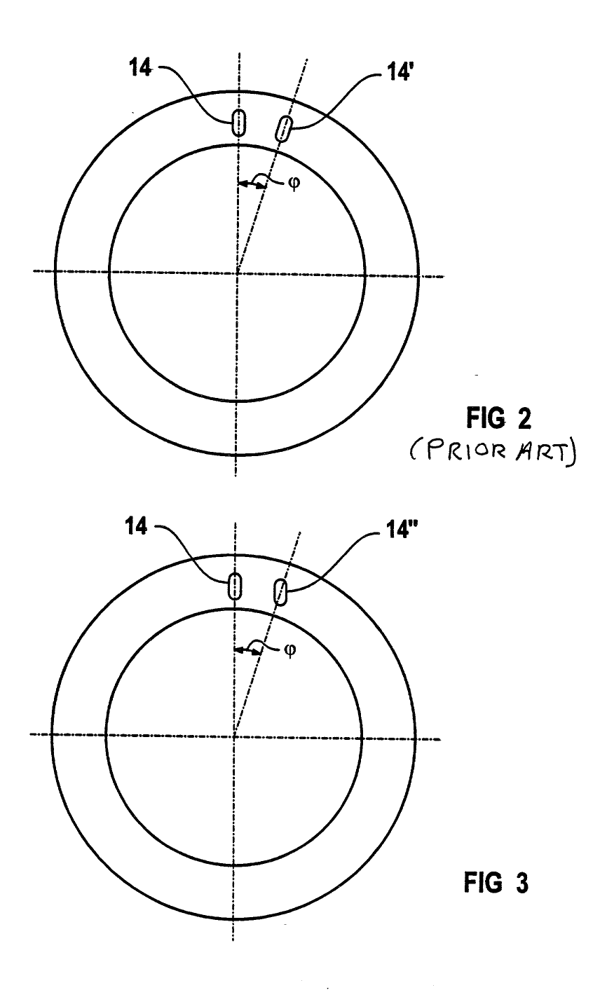

A magnet system 13 produces the main magnetic field and is fashioned as a quadrupole magnet field system in the exemplary embodiment. The electron beam 6 can be deflected and focused with this main magnetic field, with the magnet system 13 driven by control unit 15 of a known type which need not be described in greater detail, so that a nearly line-shaped focal spot 14 arises at the incident area of the anode dish 9 and the initially described spring focus effect is achieved by azimuthal displacement, either time-dependent or periodic (FIGS. 2 and 3).

The displacement of the focal spot is undertaken in a known way by the φ coils of the main magnetic field magnet 13. These act like the R-coils in a first approximation, i.e. they generate a dipole field. The R-coils and the φ coils reside orthogonally relative to one another, so that the two dipole fields also reside orthogonally relative to one another. As a result of the suitable selection of the current intensities, the electron beam 6 can be rotated around the rotational axis of the rotating bulb. When the focal spot is shaped by the quadrupole components of the main magnetic field magnet 13 to form a radial line, it remains radially aligned during the rotation. This, however, should be prevented.

The inventive coil arrangement generates a highly non-uniform field, resulting in parts of the focal spot lying at different radial distances from the bulb's rotational axis respectively experiencing different forces. This results in only the coil only rotating and hardly offsets the electron beam 6. In interaction with the φ coils of the main magnetic field magnet 13, a nearly parallel displacement of the focal spot is thus achieved (FIG. 3).

The vacuum housing 1 of the x-ray tube is surrounded by a flow guide body 16, only a portion of which is shown in the lower right part of FIG. 1 for clarity.

The flow guide body 16 is fashioned shell-like and is separated into two halves as viewed in the longitudinal direction, with one shell half surrounds, for example, the upper half of the vacuum housing in the illustration and the other half surrounding the lower half of the vacuum housing in the illustration. A gap 17 that mainly serves the purpose of allowing a coolant, usually a cooling and insulating oil, to flow through, is provided between the rotating vacuum housing 1 and the stationary flow guide body 16 arranged at the exterior housing (not shown) of the x-ray radiator containing the x-ray tube.

In the exemplary embodiment, the coil arrangement is a flat air coil 18 that is secured to the flow guide body 16 at one side, i.e. at one of the aforementioned halves. As can be seen from the plan view shown in broken lines (shown offset by 90°), the air coil 18 is relatively narrow and is fashioned with an elongated shape and can be composed of one or more windings. Advantageously, the coil 18 extends nearly parallel over the entire region of the electron beam path.

The air coil 18 is supplied with constant current from a supply source (not shown) that, for example, can contain the control unit 15. The amplitude and direction of the current are coupled to the φ current of the main magnet system 13 with which the deflection of the electron beam 6 is also produced for achieving the spring focus.

The advantage that can be achieved with the invention is explained on the basis of FIGS. 2 and 3.

As an example, FIG. 2 shows the azimuthal displacement of the focal spot 14 onto a focal spot 14′ as occurs given an embodiment according to the prior art.

It can be seen from the illustration that the focal spot 14″ is rotated compared to the initial focal spot 14.

FIG. 3 shows the displacement of the focal spot 14 onto a focal spot 14″ as occurs with the inventively provided air coil 18.

It can be seen from the comparison that the focal spot 14″ proceeds nearly parallel to the initial focal spot 14. The focal spot rotation present in FIG. 2 in the prior art has been practically completely compensated.

It should be noted that the inventive measures can be used not only for x-ray tubes employed in computed tomography, wherein the offset lies at approximately ±2 mm, but also can be employed in stereo x-ray devices wherein the focal spot offset is far greater.

Although modifications and changes may be suggested by those skilled in the art, it is the intention of the inventors to embody within the patent warranted hereon all changes and modifications as reasonably and properly come within the scope of their contribution to the art.

We claim as our invention:

1. An X-ray tube comprising:
a vacuum housing;
a cathode and an anode disposed in said vacuum housing, said cathode emitting an electron beam which strikes said anode;
a primary magnet which generates a primary magnetic field through which said electron beam proceeds between said cathode and said anode for deflecting and focusing said electron beam to form a focal spot on said anode which is azimuthally variable between a first position and a second position, said focal spot having an axis; and
a coil arrangement spacial separate from said primary magnet comprising at least one coil which generates an additional magnetic field through which said electron beam proceeds between said cathode and said anode, said additional magnetic field being nonuniform and causing parallel alignment of said axis of said focal spot at said first and second positions.

2. An x-ray tube as claimed in claim 1 comprising bearings at which said vacuum housing is rotatably mounted.

3. An x-ray tube as claimed in claim 1 wherein said at least one coil of said coil arrangement is an elongated, flat air coil.

4. An x-ray tube as claimed in claim 3 wherein said air coil is oriented substantially parallel to a portion of a path of said electron beam between said cathode and said anode.

5. An x-ray tube as claimed in claim 1 further comprising a flow guide body surrounding said vacuum housing and substantially conforming to an exterior shape of said vacuum housing, said body forming a gap between said body and said housing adapted to allow coolant flow through said gap.

6. An x-ray tube as claimed in claim 5 wherein said flow guide bode is longitudinally divided into a base section and a cover section, and wherein said at least one coil is disposed in said cover section.
